(19) United States
(12) Patent Application Publication
(10) Pub. No.: US 2024/0227467 A1
(43) Pub. Date: Jul. 11, 2024

(54) METHOD FOR CONTROLLING A TIRE PRESSURE MONITORING SYSTEM

(71) Applicant: ZF CV Systems Global GmbH, Bern (CH)

(72) Inventors: Christian Cornelius, Springe (DE); Jan Leon Kaminski, Bemerode (DE); Alexander Rodenberg, Braunschweig (DE); Michael Schomburg, Barsinghausen (DE)

(21) Appl. No.: 18/612,880

(22) Filed: Mar. 21, 2024

Related U.S. Application Data
(63) Continuation of application No. PCT/EP2022/075253, filed on Sep. 12, 2022.

(30) Foreign Application Priority Data
Sep. 28, 2021 (DE) 10 2021 125 121.4

(51) Int. Cl. B60C 23/04

(52) U.S. Cl. CPC B60C 23/0416; B60C 23/0471

(57) ABSTRACT

A vehicle having a controller, a main and a buffer memory, and a pressure sensor for each wheel. At certain time intervals after triggering, tire sensor modules transmit a sensor data record by radio, containing an individual identification code, a tire pressure and trigger information. For quick and easy assignment of wheel positions to tire sensor modules after a wheel change, after switching on the ignition or the electrical system, a detection function and subsequently and conditionally a check function are carried out. During the detection function, triggering of all modules in an order characterizing the wheel positions is expected. The controller receives the records of the triggered modules and stores them in the order received. The check function checks the records stored in the buffer memory for plausibility and, in the event of a positive result, the records are stored in the main memory instead of older records.

### CROSS-REFERENCE TO RELATED APPLICATIONS

This application is a continuation application of international patent application PCT/EP2022/075253, filed Sep. 12, 2022, designating the United States and claiming priority from German application 10 2021 125 121.4, filed Sep. 28, 2021, and the entire content of both applications is incorporated herein by reference.

### TECHNICAL FIELD

The disclosure relates to a method for controlling a tire pressure monitoring system of a vehicle, which has an electronic control unit with a receiver unit, a main memory and a buffer memory as well as a tire sensor module with a transmitter/receiver unit, a battery and a pressure sensor for each vehicle wheel, wherein the tire sensor modules each transmit a sensor data record by radio at certain time intervals and after triggering, which contains at least one unique identification code, a tire pressure value and trigger information.

### BACKGROUND

Vehicles of the so-called category M1, that is, passenger cars and motorhomes, which received a new type approval from 1 Nov. 2012 or were newly registered from 1 Nov. 2014, must be equipped with a tire pressure monitoring system in the EU in accordance with EU Regulation 661/2009. This tire pressure monitoring system is used to determine the tire pressure of the of the vehicle wheels and to warn of incorrect tire pressure or a loss of pressure in one of the wheel tires. The increasing use of tire pressure monitoring systems and the associated driving at the correct tire pressures is intended to reduce fuel consumption and CO₂ emissions of vehicles and to avoid accidents due to incorrect tire pressures and tire damage. Since driving with the right tire pressure reduces tire wear in addition to reducing fuel consumption, nowadays heavy commercial vehicles in particular, such as buses, trucks, semi-trailers and trailers, are usually also equipped with a tire pressure monitoring system, although this is not yet mandatory for these vehicle categories.

Indirectly acting tire pressure monitoring systems, in which deviations of the tire pressures from the target pressures are determined via the wheel speed sensors of the respective ABS brake system on the basis of the speed differences that occur due to changes in the rolling radii of the vehicle wheels, have not been able to establish themselves on the vehicle market. For this reason, nowadays almost exclusively directly acting tire pressure monitoring systems are used, in which tire pressures are recorded directly via pressure sensors, which are arranged either externally, that is, outside the respective wheel tire, with a connection to the tire valve on the wheel rim in question, or internally, that is, inside the respective wheel tire on the wheel rim or wheel tire. The pressure sensors are usually part of tire sensor modules, each of which has a transmitting and receiving unit as well as a battery in addition to the pressure sensor. In addition, a temperature sensor and an accelerometer can also be arranged on it. At certain time intervals and after triggering, the tire sensor modules transmit a sensor data record by radio, which contains at least an individual identification code (Sensor-ID for short), a tire pressure value and trigger information. These sensor data records are received and processed by an electronic control unit. The control unit is connected to a display device, which is arranged in the area of the driver's seat in the towing vehicle, for example, and on which the tire pressures or at least warning signals in the event of incorrect tire pressures are displayed. For this purpose, the control unit can also be wirelessly connected to a display device on the trailer of a commercial vehicle or to a mobile display and control unit of a vehicle driver via a radio connection.

A tire pressure monitoring system specially configured for heavy commercial vehicles is described in WABCO GmbH's information document 815 020 229 3 “OPTITIRE™ Tire Pressure Monitoring for Commercial Vehicles—System Description” with regard to its structure, functionality and operation. This information document can be downloaded from the company's website as a PDF document from the Internet.

When driving a commercial vehicle or another vehicle, tire damage may occur, which makes it necessary to change the wheel. The problem here is to correct the assignment of the wheel positions to the tire sensor modules. This problem arises, for example, if the previously used tire sensor module has been destroyed by a burst tire and can therefore no longer be used at the previously assigned wheel position. However, a similar situation can also arise independently of tire damage if summer wheels are exchanged for winter wheels, or if vehicle wheels are swapped with each other to ensure uniform tire tread wear.

If the driver is left to his or her own devices, the defective vehicle wheel mounted on a vehicle axle can be replaced with a spare wheel. In this case, the wheel positions of the two vehicle wheels concerned are interchanged, so that the driver will be shown incorrect vehicle wheels on the mentioned information device for these two wheel positions if no corrections are made. For the other vehicle wheels, the assignment of the wheel positions to the tire sensor modules remains unchanged.

However, if the driver calls a workshop truck for help or reaches a workshop, a new vehicle wheel with a new individual identification code (Sensor-ID) can also be mounted at the wheel position where the vehicle wheel with the tire damage was previously located as an alternative to fitting a spare wheel that is carried in the vehicle.

In this case, the control unit receives the sensor data records of the newly fitted vehicle wheel with a previously unknown Sensor-ID, and the sensor data records of the removed vehicle wheel with the known Sensor-ID are no longer received. This means that only the Sensor-ID at the wheel position in question changes, which must be brought to the attention of the control unit in an appropriate manner. For all other vehicle wheels, the assignment of the wheel positions to the tire sensor modules remains unchanged. If the position of one or more of the other vehicle wheels has been changed during this workshop visit, the control unit will also not know anything about it without further action and will display incorrect wheel position related values.

There is therefore a need to assign the correct wheel positions to the tire sensor modules of the replaced or newly fitted vehicle wheels as quickly as possible in a simple way after a wheel change. Tire pressure monitoring systems are ¬known in which the assignment of wheel positions to the tire¬ sensor ¬modules is carried out in an automated manner when the vehicle is stationary or while driving. However, such assignment methods disadvantageously require a high level of equipment cost and/or a relatively long period of time.

A method described in DE 196 08 478 A1 for assigning wheel positions to tire sensor modules requires a tire pressure monitoring system with multiple receiving antennas, each of which is arranged near a wheel position on the vehicle frame and is connected to an electronic control unit. The assignment of the wheel positions to the tire sensor modules is carried out according to the highest signal level at each of the receiving antennas when receiving the sensor data records emitted by the tire sensor modules at certain time intervals.

From DE 102 50 942 A1, a method for assigning wheel positions to tire sensor modules is known, in which the assignment of the wheel positions is carried out while driving on the basis of changes in tire pressures due to dynamic driving processes, such as cornering, braking and acceleration.

In the case of the above-mentioned tire pressure monitoring system OPTITIRE™ from WABCO GmbH, it is possible to assign the wheel positions to the tire sensor modules with a personal computer or a laptop that is carried in the vehicle on which corresponding licensed software is stored and which is connected to the tire pressure monitoring system with a suitable connection cable. Since these prerequisites are often not realized, there is a need for further improvement.

### SUMMARY

It is an object of the disclosure to provide a method for controlling a tire pressure monitoring system of a vehicle with which the assignment of the wheel positions to the tire sensor modules after a wheel change is comparatively quick and easy for a driver or fitter.

This object is, for example, achieved by a method of controlling a tire pressure monitoring system of a vehicle, the vehicle having an electronic control unit with a receiver unit, a main memory, a buffer memory, a tire sensor module with a transmitter/receiver unit, a battery, and a pressure sensor for each vehicle wheel, wherein the tire sensor modules each transmit a sensor data record by radio at certain time intervals and after a triggering, which contains at least an individual identification code, a tire pressure value, and trigger information. The method includes: after switching on an ignition or switching on an electrical system of the vehicle, executing a detection function followed by a conditional check function, wherein during the execution of the detection function, all tire sensor modules are expected to be triggered in a sequence that identifies wheel positions; receiving the sensor data records of the triggered tire sensor modules by the control unit and storing the sensor data records of the triggered tire sensor modules in the buffer memory in an order in which they were received; wherein a plausibility of the sensor data records stored in the buffer memory is checked in the check function; and, wherein, in the event of a positive check result, the sensor data records stored in the buffer memory are stored in the main memory instead of older sensor data records.

Accordingly, the disclosure relates to a method for controlling a tire pressure monitoring system of a vehicle, in particular a commercial vehicle, which has an electronic control unit with a receiver unit, a main memory and a buffer memory as well as a tire sensor module RSM with a transmitting/receiving unit, a battery and a pressure sensor for each vehicle wheel, wherein the tire sensor modules RSM transmit a sensor data record SDS by radio at certain time intervals and after triggering, which contains at least an individual identification code (Sensor-ID), a tire pressure value and trigger information.

According to the disclosure, in order to achieve the object at hand, it is provided that after switching on the ignition or after switching on the onboard electrical system of the vehicle, a detection function EF and then conditionally a check function PF are carried out, that while the detection function EF is carried out a triggering of all tire sensor modules RSM in a sequence characterizing the wheel positions is expected, that the sensor data records SDS of the triggered tire sensor modules are received by the control unit and stored in the buffer memory in the order in which they are received, and that in the check function the sensor data records SDS stored in the buffer memory are checked for plausibility and are stored in the main memory instead of older sensor data records in the event of a positive check result.

Accordingly, a control method according to the disclosure uses a tire pressure monitoring system of a vehicle which has an electronic control unit with a receiver unit, a main memory and a buffer memory as well as a tire sensor module with a transmitting and receiving unit, a battery and a pressure sensor for each vehicle wheel. When the control unit is put into operation for the first time, the basic vehicle configuration data are permanently stored in the main memory, for example the presence of three vehicle axles, each with two wheels per vehicle axle. These vehicle configuration data can only be changed via separate diagnostic software and therefore remain constant when using the described method according to the disclosure. At certain time intervals and after triggering, the tire sensor modules transmit a sensor data record by radio that contains at least an individual identification code (Sensor-ID), a tire pressure value and trigger information.

When the tire sensor modules are triggered, they are stimulated to immediately send out sensor data records that are received by the control unit. By triggering the tire sensor modules in the order that characterizes the wheel positions, the tire sensor modules are automatically assigned the correct wheel positions with their Sensor-IDs. The triggering of the tire sensor modules can be carried out by a driver or fitter via an electronic handheld device, in the case of the tire pressure monitoring system OPTITIRE™ from WABCO GmbH, for example, with a handheld device called TPMS Manager (TPMS=Tire Pressure Monitoring System), which is aligned with the nearby tire sensor module in question and activated for a short time. In some tire pressure monitoring systems, the tire sensor modules can also be triggered via a suitable permanent magnet, which is held close to the tire sensor module in question for a short time. A triggered signal is known to be different from a regular, automatically sent signal, so that erroneous assignment of a randomly received sensor signal is avoided.

With the transfer of the sensor data records from the buffer memory to the main memory, the assignment of the wheel positions to the tire sensor modules is completed, and the tire pressures recorded by the tire sensor modules are subsequently displayed in the correct positions in the display device of the vehicle.

With the control method according to the disclosure, the detection and assignment of the wheel positions to the tire sensor modules can be carried out relatively quickly and easily before the start of a journey without any further prerequisites. Since the detection function EF of the method according to the disclosure is carried out before each start of a journey, regardless of whether a wheel change has taken place or not, it can also be carried out without a result, that is, without a new assignment of wheel positions to specific tire sensor modules. If no triggered sensor signals were received while the detection function EF was carried out, the check function PF is not performed.

The check function PF is preferably carried out after the detection function EF has been completed during the subsequent journey of the vehicle. This can be used to ensure that carrying out the detection function EF has been terminated.

In order to control the beginning and end of the method according to the disclosure, it may be provided that the detection function EF is started when the ignition or the electrical system of the vehicle is switched on and is terminated after a specified running time Δt_{L}, (t≥Δt_{L}).

The running time Δt_{L} of the detection function EF is set to a period of time during which all tire sensor modules can be conveniently triggered by a person in the intended order. The running time Δt_{L} of the detection function can therefore be sensibly parameterized and can be five minutes for example (Δt_{L}=5 min).

Although the running time Δt_{L} of the detection function is such that all tire sensor modules can be conveniently triggered in the intended order, it can happen that the driver or fitter is held up during the triggering process and therefore does not manage to trigger all tire sensor modules within the running time Δt_{L} of the detection function. As an extension of a method according to the disclosure, it can therefore be provided that the running time Δt_{L} of the detection function is extended by a fixed period of time Δt_{Z}, (Δt_{L}=Δt_{L}+Δt_{Z}) if the number n_{S} of the sensor data records of triggered tire sensor modules received by the control unit has reached or exceeded a specified minimum number n_{S_min}, (n_{S}≥n_{S_min}) at the end of the running time Δt_{L}, but has not yet reached the number of vehicle wheels n_{R} of the vehicle (n_{S}<n_{R}).

The time span Δt_{Z}, by which the running time Δt_{L} of the detection function is extended, can be sensibly parameterized and, for example, set to another five minutes (Δt_{Z}=5 min), so that the running time Δt_{L} of the detection function can then be a total of 10 minutes (Δt_{L}=10 min).

For example, the minimum number n_{S_min} of the received sensor data records of triggered tire sensor modules, after which the running time Δt_{L} of the detection function is extended, can be set to half the number of vehicle wheels n_{R}, (n_{S_min}=0.5 n_{R}), which is rounded down to an integer as needed, that is, in the case of an odd number of vehicle wheels n_{R}.

Furthermore, it may be provided that the running time Δt_{L} of the detection function EF is extended until the start of the journey if at least one triggered sensor data record SDS has been received by the control unit, and that the detection function EF is terminated without a result if the triggered sensor data records SDS of all tire sensor modules of the vehicle have not been received by the start of the journey.

Sensor data records of non-triggered tire sensor modules received during the running time Δt_{L} of the detection function are ignored because they are irrelevant for the assignment of the wheel positions to the tire sensor modules. The sensor data records of triggered and non-triggered tire sensor modules can be differentiated based on the trigger information in the sensor data records, for example a “1” for triggered and a “0” for non-triggered.

During the triggering of the tire sensor modules, multiple triggering of a tire sensor module may occur inadvertently, resulting in the sequential transmission of multiple sensor data records by the same tire sensor module. In order to avoid a possible interference with the assignment of the wheel positions to the tire sensor modules, it can be provided that during the running time Δt_{L} of the detection function, sensor data records received multiple times from the same triggered tire sensor modules are only taken into account once, and that the sensor data records previously stored in the buffer memory are overwritten with the sensor data records of the same tire sensor modules received thereafter.

The reception of each sensor data record of a triggered tire sensor module is advantageously confirmed by the output of an acoustic and/or visual signal. As an acoustic reception confirmation signal, for example, a controllable bleeder solenoid valve of an air brake system of the vehicle can be opened once for a short time. For example, the brake lights or direction indicator lights of the vehicle can be switched on briefly as a visual reception confirmation signal.

The reception of a number n of sensor data records received by triggered tire ¬sensor modules, that is, a complete number n_{S} of sensor data records received, corresponding to the number n_{R} of vehicle wheels can also be advantageously confirmed by the output of an acoustic and/or visual signal. As an acoustic reception confirmation signal, for example, a controllable bleeder solenoid valve of the air brake system of the vehicle can be opened for a short time twice in succession. As a visual reception confirmation signal, for example, the brake lights or direction indicator lights of the vehicle can be switched on for a short time twice in succession.

The detection function can be terminated prematurely if, before the expiration of the running time (t<Δt_{L}), the number n_{S} of sensor data records of triggered tire sensor modules received by the control unit corresponds to the number n_{R} of the wheels of the vehicle (n_{S}=n_{R}). _{SR}

Since an interruption in the journey is not necessarily associated with a wheel change, or since the triggering of the tire sensor modules may not be carried out immediately after a wheel change for safety reasons or may have to be aborted, it may be advantageous provided that the detection function is also terminated prematurely even if the drive motor of the vehicle is started or the vehicle starts moving before the expiry of the running time Δt_{L} (driving speed v_{F}>0). If, for example, the vehicle was in an unsafe place when changing the wheel and the triggering was not possible there, the triggering of the tire sensor modules can then be carried out in a safe parking space, for example.

The check function PF is only carried out if the number n_{S} of the sensor data records of triggered tire sensor modules received in the detection function is equal to the number n_{R} of vehicle wheels (n_{S}=n_{R}).

In the check function PF, the plausibility of the received sensor data records of triggered tire sensor modules is determined, for example, if the wheel positions of at least two tire sensor modules are interchanged compared to the wheel positions assigned to the two tire sensor modules before the trip interruption.

Similarly, in the check function PF the plausibility of the received sensor data records from triggered tire sensor modules is also determined, for example, if at least one wheel position is assigned to a tire sensor module with a new Sensor-ID, and the Sensor-ID to which this wheel position was assigned before the trip interruption has been omitted.

If the check result of the check function PF is negative and it is therefore not possible to assign the wheel positions to the tire sensor modules, an acoustic and/or visual warning signal is emitted in accordance with another development of the method in order to draw the attention of the driver or fitter to the fault and, if necessary, to induce him to trigger the tire sensor modules again after a restart of the detection function. To restart the detection function, the driver or fitter only needs to switch off the ignition or the electrical system and switch it on again.

As an acoustic warning signal, for example, a controllable bleeder solenoid valve of the air brake system of the vehicle can be opened for a short time three times in succession. As a visual warning signal, for example, the brake lights or direction indicator lights of the vehicle can be switched on for a short time three times in succession.

### BRIEF DESCRIPTION OF DRAWINGS

The invention will now be described with reference to the drawings wherein:

FIG. 1 shows a first part of a sequence of a method according to the disclosure for controlling a tire pressure monitoring system in the form of a schematic flow diagram; and,

FIG. 2 shows a second part of a sequence of a method according to the disclosure for controlling a tire pressure monitoring system in the form of a schematic flow diagram.

### DETAILED DESCRIPTION

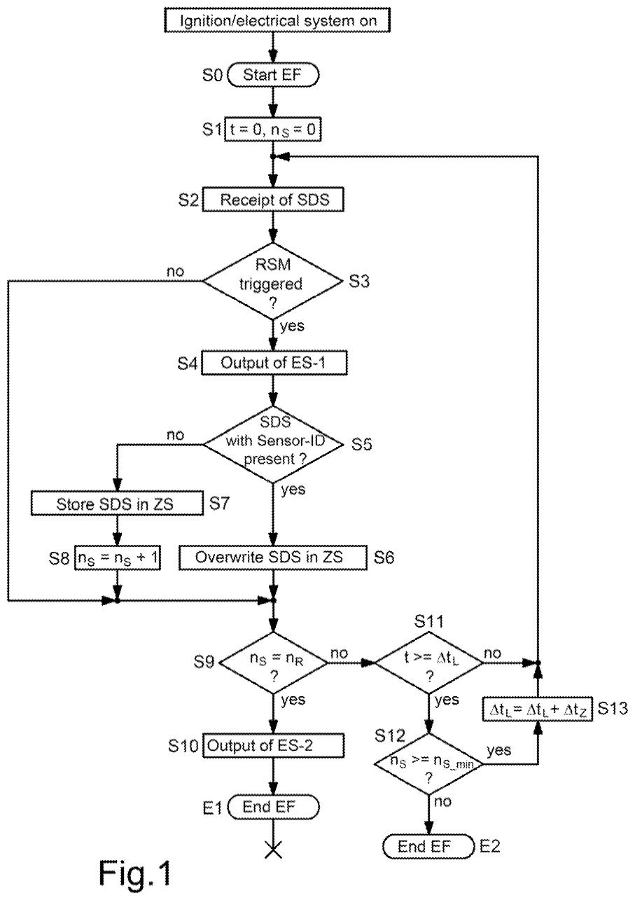

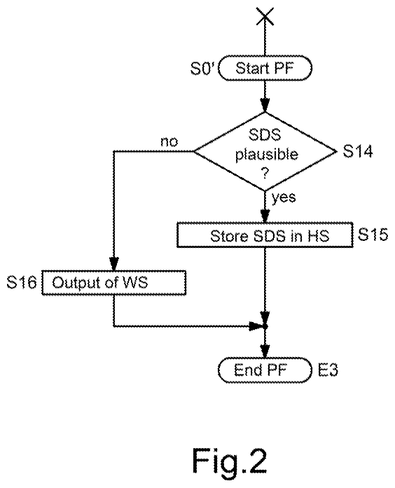

FIGS. 1 and 2 show a possible sequence of a method according to the disclosure for controlling a tire pressure monitoring system of a vehicle according to the disclosure in the form of a flow diagram. The method is used to assign wheel positions to the tire sensor modules RSM arranged in or on the wheel tires of the vehicle wheels after a break in the journey, during which a wheel change may have taken place. If, for example, a wheel change has taken place during the interruption of the journey, during which at least one vehicle wheel with a defective wheel tire mounted on a vehicle axle has been replaced with a spare wheel or with a new vehicle wheel, the wheel positions must be assigned to the relevant tire sensor modules for the replaced or newly fitted vehicle wheels. An update of the assignment of tire sensor modules to wheel positions other than the previous ones is also necessary when vehicle wheels are interchanged with each other by axle or by side to achieve uniform tire wear. The same applies when changing from vehicle wheels with summer tires to vehicle wheels with winter tires.

For this purpose, the method provides for the driver or fitter to trigger the tire sensor modules of all vehicle wheels in a designated order, for example starting with the tire sensor module of the right front wheel clockwise around the vehicle to the tire sensor module of the left front wheel. Due to the triggering, the tire sensor modules each transmit a sensor data record by radio, which contains at least an individual identification code (Sensor-ID), a tire pressure value and trigger information. The order of triggering determines the wheel positions. The assignment of the wheel positions to¬ the tire sensor modules within the tire pressure monitoring system is carried out in an automated manner using the control method described below. This assumes that the basic vehicle configuration data are permanently stored in the tire pressure monitoring system, such as the number of vehicle axles and the number of wheels per vehicle axle. These vehicle configuration data can only be changed via a separate diagnostic software and therefore remain constant during the use of the described method according to the disclosure.

According to the flow diagram shown in FIG. 1, after switching on the ignition or the electrical system of the vehicle, a detection function EF is started (function start S0). Then, in process step S1, a time counter and a counter n_{S} indicating the number of received sensor data records SDS of triggered tire sensor modules RSM are initialized, that is, set to the value zero. Thereafter, an electronic control unit receives a sensor data record SDS emitted by a tire sensor module RSM (procedure step S2), which may have been emitted by the tire sensor module in question due to a triggering or due to an elapsed time interval. Therefore, in the following procedure step S3, it is checked whether the tire sensor module RSM of the received sensor data record was triggered or not, which is carried out on the basis of the trigger information (value “1” or value “0”) in the sensor data record.

If the check of the triggering is positive, an acoustic and/or visual reception confirmation signal ES-1 is issued as feedback for the driver or fitter (procedure step S4). As an acoustic reception confirmation signal, for example, a controllable bleeder solenoid valve of an air brake system of the vehicle can be opened once for a short time. As a visual reception confirmation signal, for example, the brake lights or direction indicator lights of the vehicle can be switched on once for a short time.

Then, in process step S5, it is checked whether a sensor data record SDS of the tire sensor module with the same Sensor-ID has already been received and stored in a buffer memory ZS. If this is the case, the relevant sensor data record SDS in the buffer memory ZS is overwritten with the currently received sensor data record SDS (procedure step S6). If no sensor data record SDS with the relevant Sensor-ID has yet been saved, the currently received sensor data record SDS is stored at the designated location in the buffer memory ZS (procedure step S7) and in the subsequent process step S8 the counter n for the signal data records SDS received due to triggering is increased by one.

After process step S6 or process step S8, it is checked whether the number n_{S} of the sensor data records SDS received due to triggering corresponds to the number n_{R} of vehicle wheels, that is, whether sensor data records of all vehicle wheels have been received (process step S9). In the event of a positive check result, that is, the presence of a complete number of signal data records SDS, an acoustic and/or visual reception confirmation signal ES-2 is issued in procedure step S10 to inform the driver or fitter. As an acoustic reception confirmation signal, for example, a controllable bleeder solenoid valve of the air brake system of the vehicle can be opened successively in a defined sequence, such as twice for a comparatively short time and twice for a comparatively long time. As a visual reception confirmation signal, for example, the brake lights or direction indicator lights of the vehicle can be switched on successively for a short time in a defined sequence, such as twice for a comparatively short time and twice for a comparatively long time. The type and duration of the described confirmation signal are freely adjustable and can be combined with other confirmation signals if required. After that, the detection function ends regularly (end of function E1) and a check function PF is subsequently carried out, which is shown in the flow diagram of FIG. 2 and will be described later.

If the check for the existence of a complete number of sensor data records SDS in procedure step S9 is negative, in procedure step S11 it is checked whether a running time Δt_{L} of the detection function EF set to five minutes, for example, has already been reached or exceeded. If the check result is negative, the method is branched back to before process step S2, in which another signal data record can be received. If the check result in procedure step S11 is positive, that is, the running time Δt_{L} of the detection function EF has been reached or exceeded, it is checked in procedure step S12 whether the number n_{S} of sensor data records SDS received due to a triggering has reached or exceeded a specified minimum number n_{S_min}. If this is not the case, the detection function EF ends without a result (end of function E2), that is, without a new assignment of wheel positions to certain tire sensor modules. This also marks the end of the control method according to the disclosure. If the check result is positive, the running time Δt_{L} of the detection function EF is increased in process step S13 by a time span Δt_{Z}, for example set to five minutes, and then the method is branched back to before process step S2. This gives the driver or fitter the opportunity to complete an incomplete sequence of trigger operations and thereby achieve a regular termination of the detection function EF.

According to the flow diagram shown in FIG. 2, after the regular end of the detection function EF (end of function E1), the check function PF is started (function start S0′). In the check function PF, the signal data records received in the detection function EF and stored in the buffer memory SDS are first checked for plausibility (procedure step S14). The plausibility of the received sensor data records SDS of triggered tire sensor modules is determined, for example, if the wheel positions of at least two tire sensor modules are interchanged compared to the wheel positions assigned to the two tire sensor modules before the trip was interrupted. Likewise, the plausibility of the received sensor data records of triggered tire sensor modules is also determined, for example, if at least one wheel position is assigned to a tire sensor module with a new Sensor-ID, and the Sensor-ID to which this wheel position was assigned before the interruption of the journey has been omitted. The check function PF is preferably only operated while the vehicle is in motion, which ensures that the described detection function EF is completed and that the vehicle has left a workshop, for example.

In the event of a positive result of the plausibility check, the sensor data records SDS, which were previously stored in the ZS buffer memory, are stored in a main memory HS of the control unit (procedure step S15), whereby the corresponding assignment of the wheel positions to the tire sensor modules, given by the sequence of the previous triggering of the tire sensor modules, is transferred to the subsequent control of the tire pressure monitoring system TPMS. After that, the check function PF ends (end of function E3) and with it a control method according to the disclosure.

In the event of a negative result of the plausibility check, an acoustic and/or visual warning signal WS is issued in procedure step S16 to inform the driver or fitter before the check function PF ends (end of function E3). As an acoustic warning signal, for example, a controllable bleeder solenoid valve of the air brake system of the vehicle can be opened for a short time three times in succession. As a visual warning signal, if the vehicle is not driving and the check function PF has been operated when the vehicle is at a standstill, the brake lights of the vehicle or the direction indicator lights of the vehicle can be switched on for a short time three times in succession. Since the sensor data records previously received due to a triggering are discarded with the negative check result and are not transferred to the main memory, a re-triggering of the tire sensor modules after a restart of the detection function EF is necessary for the assignment of the wheel positions. To restart the detection function EF, a driver or fitter only needs to switch off the ignition or the electrical system of the vehicle and then switch it back on.

With the control method according to the disclosure, the assignment of the wheel positions to the tire sensor modules RSM can be carried out relatively quickly and easily after an interruption of the journey without any further prerequisites.

It is understood that the foregoing description is that of the preferred embodiments of the invention and that various changes and modifications may be made thereto without departing from the spirit and scope of the invention as defined in the appended claims.

### REFERENCE SIGN LIST (PART OF THE DESCRIPTION)

EF Detection function
ES-1 Signal, reception acknowledgment signal
ES-2 Signal, reception acknowledgment signal
E1-E3 End of function
Sensor-ID Sensor Identification
n_{R} Number of vehicle wheels
_{S} Number of sensor data records received
n_{S_min} Minimum number of sensor data records received
PF Check function
RSM Tire sensor module
SDS Sensor data record
S0, S0′ Function starts
S1-S17 Procedural steps
t Time
Δt_{L} Running time
Δt_{Z} Time span
TPMS Tire pressure monitoring system
v_{F} Driving speed
WS Warning signal

1. A method of controlling a tire pressure monitoring system of a vehicle, the vehicle having an electronic control unit with a receiver unit, a main memory, a buffer memory, a tire sensor module with a transmitter/receiver unit, a battery, and a pressure sensor for each vehicle wheel, wherein the tire sensor modules each transmit a sensor data record by radio at certain time intervals and after a triggering, which contains at least an individual identification code, a tire pressure value, and trigger information, the method comprising:
after switching on an ignition or switching on an electrical system of the vehicle, executing a detection function followed by a conditional check function, wherein during the execution of the detection function, all tire sensor modules are expected to be triggered in a sequence that identifies wheel positions;
receiving the sensor data records of the triggered tire sensor modules by the control unit and storing the sensor data records of the triggered tire sensor modules in the buffer memory in an order in which they were received;
wherein a plausibility of the sensor data records stored in the buffer memory is checked in the check function; and,
wherein, in the event of a positive check result, the sensor data records stored in the buffer memory are stored in the main memory instead of older sensor data records.

2. The method of claim 1, wherein the check function is carried out after the detection function has been completed while the vehicle is in motion.

3. The method of claim 1, wherein the detection function is started when the ignition is switched on or when the electrical system of the vehicle is switched on and is terminated after a specified running time.

4. The method of claim 3, wherein the running time of the detection function is set to a period of time in which, depending on the vehicle, all tire sensor modules are configured to be conveniently triggered by a person in an intended order.

5. The method of claim 1, wherein a running time of the detection function is extended by a fixed period of time if a number of the sensor data records of triggered tire sensor modules received by the control unit at the end of the running time has reached or exceeded a specified minimum number although the number of sensor data records received has not yet reached a number of vehicle wheels of the vehicle.

6. The method of claim 5, wherein the minimum number of the received sensor records of the triggered tire sensor modules is set to half the number of vehicle wheels rounded down to an integer.

7. The method of claim 1, wherein a running time of the detection function is extended until the start of a journey if at least one triggered sensor data record has been received by the control unit and the detection function is terminated without result if the triggered sensor data records of all tire sensor modules of the vehicle have not been received by the start of the journey.

8. The method of claim 1, wherein the received sensor data records of non-triggered tire sensor modules are ignored during a running time of the detection function.

9. The method of claim 1, wherein during a running time of the detection function, sensor data records of the same triggered tire sensor modules received multiple times are only taken into account once, and the sensor data records previously stored in the buffer memory are each overwritten with the sensor data records of the same tire sensor modules received thereafter.

10. The method of claim 1, wherein the reception of each sensor record of a triggered tire sensor module is confirmed by an output of at least one of an acoustic signal and a visual signal.

11. The method of claim 10, wherein a controllable bleeder solenoid valve of an air brake system of the vehicle is opened once for a short time as an acoustic reception confirmation signal.

12. The method of claim 10, wherein brake lights or direction indicator lights of the vehicle are switched on once for a short time as a visual reception confirmation signal.

13. The method of claim 1, wherein the reception of a number of received sensor data records of triggered tire sensor modules corresponding to a number of vehicle wheels is confirmed by an output of at least one of an acoustic and a visual signal.

14. The method of claim 13, wherein a controllable bleeder solenoid valve of the air brake system of the vehicle is briefly opened twice in succession as an acoustic reception acknowledgment signal.

15. The method of claim 13, wherein brake lights or direction indicator lights of the vehicle are switched on briefly twice in succession as a visual reception confirmation signal.

16. The method of claim 1, wherein the detection function is terminated prematurely if, before an end of a running time, a number of the sensor data records of triggered tire sensor modules received by the control unit corresponds to a number of vehicle wheels of the vehicle.

17. The method of claim 1, wherein the detection function is terminated prematurely if a drive motor of the vehicle is started or the vehicle starts moving before an end of a running time.

18. The method of claim 1, wherein the check function is only performed if a number of the sensor data records of triggered tire sensor modules received in the detection function corresponds to a number of vehicle wheels.

19. The method of claim 1, wherein the plausibility of the received sensor data records of triggered tire sensor modules is determined in the check function, if the wheel positions of at least two tire sensor modules are interchanged compared to the wheel positions assigned to the two tire sensor modules prior to an interruption of a journey.

20. The method of claim 1, wherein the plausibility of the received sensor data records of triggered tire sensor modules is determined in the check function if at least one wheel position is assigned to a tire sensor module with a new Sensor-ID and the Sensor-ID to which this wheel position was assigned before an interruption of a journey has been omitted.

21. The method of claim 1, wherein at least one of an acoustic and a visual warning signal is issued if the check result of the check function is negative.

22. The method of claim 21, wherein a controllable bleeder solenoid valve of an air brake system of the vehicle is briefly opened three times in succession as an acoustic warning signal if the check result of the check function is negative.

23. The method of claim 21, wherein brake lights or direction indicator lights of the vehicle are switched on for a short time three times in succession as a visual warning signal if the check result of the check function is negative.
